(19) United States
(12) Patent Application Publication
(10) Pub. No.: US 2006/0156229 A1
(43) Pub. Date: Jul. 13, 2006

(54) Method and system for web-based print requests

(76) Inventor: Fabian F. Morgan, Austin, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/032,883

(22) Filed: Jan. 11, 2005

(51) Int. Cl. G06F 17/21; G06F 17/24; G06F 3/12

(52) U.S. Cl. 715/527; 715/501.1; 358/1.15

(57) ABSTRACT

A print preparation assistant for a web browser system which allows a user to select multiple links within a top page for printing. The system automatically retrieves the documents and web pages pointed to by the selected links, searches for printer-friendly versions of each document, and prints the collection of retrieved documents, web pages, and printer-friendly versions to a single print job.

### CROSS-REFERENCE TO RELATED APPLICATIONS (CLAIMING BENEFIT UNDER 35 U.S.C. 120)

None.

### CROSS-REFERENCE TO RELATED APPLICATIONS

None.

### FEDERALLY SPONSORED RESEARCH AND DEVELOPMENT STATEMENT

This invention was not developed in conjunction with any Federally-sponsored contract.

### MICROFICHE APPENDIX

Not applicable.

### INCORPORATION BY REFERENCE

None.

### BACKGROUND OF THE INVENTION

1. Field of the Invention

This invention relates to technologies which allow users of browsers to print documents, some of which are specially formatted for printing instead of viewing through a browser.

2. Background of the Invention

With the availability of the Internet today, there is a massive amount of information being transferred. People can stay current on the latest news, articles, or stories within a click of a user's fingertip. Many users utilize this benefit by browsing on the web to get updated sports scores, conduct research for work projects, or simply stay abreast of latest world news.

Because of the enormous amount and wide variety of types of information available, users sometimes will print out copies of web pages to read during their leisure times such as lunch, on a commute, or to save for later usage. By selecting and printing only what a user wants to keep or save, the need to purchase the traditional stacks of newspapers or magazines itself is minimized or eliminated as hard copies of uninteresting stories are not printed or stored.

Web browser programs and computers can print any web page that a user is viewing, but the printed copy of the web page is often not an exact duplicate of the page as viewed through the web browser. This is because Hyper Text Markup Language (“HTML”), as well as other types of web objects such as Macromedia's Flash or Apple's QuickTime, are “interpreted” by the web browser program and then are rendered to a viewable image in the web browser user interface. The same web page viewed in two different web browser programs may even appear differently. When a user selects a print option in a web page, the web browser re-interprets the current web page for printing on the selected printing device, often adjusting the color content, aspect ratio, text size, image resolutions, and sometimes omitting items such as backgrounds. The final printed product, however, is sometimes less than optimal, as it may contain many partially filled pages, omitted information, etc.

To assist site “visitors” with obtaining properly formatted printouts of pages on the site, many web sites offer visitors links to their own “printer-friendly” versions of pages. These linked items often include web pages which have minimized content (e.g. no backgrounds, banners, Flash, etc.) which tends to print more reliably, or they are in an alternate format which assures accurate printing across multiple printers and computing platforms (e.g. Adobe's Acrobat Portable Document Format).

Turning to FIG. 1, such ordinary options are illustrated using a portion of a web browser window (100) that is displayed on a media such as a computer monitor, television, or personal digital assistant (“PDA”). Typically, near the top of the window frame for the web browser there is a command menu bar (102), often including a “File” option (102) for file-oriented operations (e.g. opening, saving, etc.), a “Print” option (103) for printing the information shown in the display area of the web browser, a “Bookmark” option, and “Goto Address Bar” (104) for typing in a web address to “point” the web browser to a specific web server or page.

FIG. 1 indicates a generalized layout of a web browser menu, while each specific web browser product may offer similar functions, terms or operations in different manners. For example, some browser providers such as Netscape use the term “Bookmark”, while others like Micorsoft Internet Explorer use the term “Favorite” for essentially the same function—storing an address for later recall. A cursor (12) is movable by the user with a device such as a mouse, glidepad, touchscreen, stylus, trackball, or similar user control, which usually also includes a means for indicating a selection such as double clicking a button, tapping the screen, etc.

In the Goto Address Bar (104) is shown or entered an actual Uniform Resource Locator (“URL”), “jump word”, or shortcut that is a unique accessible address, for a particular web page or file accessible on the Internet. Once the web page is loaded on the browser window, it is typical to find grouped or organized titles, subtitles, bullets, etc., (10, 11) which are linked to other web pages containing more information relative to the title, subtitle, etc. In our example of FIG. 1 from a hypothetical news web site, headlines “Earthquake rocks L.A.,” “UN sends aid,” or “Woods on Top Again” are shown as examples of such hyperlinked titles or bullets. Some graphic images (101) will also have hyperlinked documents that can perform the same actions once user selects the hyperlinked graphic image (e.g. a linked “button”, picture, banner, etc.).

User highlighting and selection of a hyperlink is illustrated in FIG. 2 which continues from FIG. 1. The cursor (12′) is placed by the user over the hyperlinked text “Earthquake rocks L.A.” which causes the item to be highlighted or indicated as selectable. For example, in some web pages, hyperlinked text is shown in an underlined blue font, but in other pages, hyperlinked text or images may change appearance upon moving the cursor over them, such as changing color or changing the appearance of the pointer (e.g. changing to a hand with finger pointed, etc.).

Next, the item is selected by the user (e.g. cursor is clicked, screen tapped, etc.). This selection initiates opening or loading the web page linked to the selected item, for example a web page that displays the detailed news story, either in the same browser window, or in a new window depending on user setup and program capabilities, such as shown in FIG. 3.

Turning to FIG. 3, the example linked web page about the headline “5.0 Quake in L.A.” is displayed (100′) by the web browser, and the Goto Address Bar (105) is updated with the current URL of that page. The actual story about the earthquake is displayed in the text section (30). At this time, the user has two options to print the article, either using the browser's print command, or by selecting a link to a printer-friendly document (31), as previously described.

To use the browser's print command, the user moves the cursor (12″) and selects the Print option on the command menu bar. This often leads to a printer dialogue or menu in which the user is allowed to pick which printer to send this particular page for printing. The information actually formatted and sent to the printer may or may not include a banner advertisement (32), backgrounds, etc., after the web browser applies certain user-specified options for printing such as scaling (e.g. make image fit to page width), font, paper page orientation, etc.

If provided on the web page, the user can also choose to “go to” a printer-friendly version of the same page by selecting a printer-friendly icon or hyperlinked text (31). This retrieves a file, document or web page which has been specially formatted for printing instead of viewing.

Once the user-selected page or document has been printed, the user may elect to return to the previous web page where he or she may select additional hyperlinks to retrieve additional articles, followed by printing them after they have been retrieved and viewed.

Using either method (or using a combination of them), a tediously manual process is followed to locate the specified web page, highlight the desired article, and print each information individually for each story, and then repeat these steps for another news article, web page, search subject, etc. This results in numerous steps that are repetitive and time-consuming. There is provided no ability for users to select any number of articles to print in a quick and efficient manner which avoids such redundant navigation operations. As such, each article or page is located individually and printed individually, which can also lead to a waste of paper on the printer in situations such as networked printers which provide a separation page between each individual print job.

Turning to FIG. 4, this repetitive process is illustrated (40). First, the user types the address of a “top” or “home” page, and then navigates to a desired web page (41). Once a page of interest is located, the user selects (42) a first linked item, bullet, topic, etc., which causes the linked page to be loaded and displayed so that the user can view (43) it. The user can then find (45) a link or icon to retrieve a printer-friendly version of the page, or can just print the page (44) using the browser's function to reformat the web page and print it. If (46) more pages are to be found and printed, the process (steps 42-45) is repeated for each item to be printed.

There exists several “multi-select” user interface methods in the art, including clicking to select a first item, followed by holding down a “control” or “shift” key and clicking on additional items which either selects a range of items or set of individually selected items.

For example, Microsoft's Windows Explorer™ provides a version of multi-select printing in which a user may view the contents of a folder on a hard drive, select a plurality of those items, and then right-click to display a menu which includes a “print” option. Alternatively, a user may “click and drag” over several items to select them, and then right-click to display the “print” option. As these items may represent a variety of data formats and file formats, such as word processor files, spreadsheets, photographs, etc., the Windows operating system accomplishes the printing of each selected item by simultaneously invoking each associated application program (e.g. a wordprocessor program for document files, a presentation program for slideshows, etc.) to print each item. This results in multiple programs being instantiated, which can place a considerable instant demand on system resources (e.g. memory, hard drive, processor bandwidth, etc.), and leads to multiple individual print jobs being sent to the printer. Additionally, Windows Explorer provides this multi-select printing function only for folder contents on a computer, but not for hyperlinked documents and pages in a web page.

One available web browser, Mozilla's Firefox™ browser, provides a feature that allows a user to open multiple view frames, each attached to a tab and containing a view of a web page, within its web browser window following a multi-item selection operation. In its browser window, a user can have several instances of web pages available simultaneously, each organized or accessed using a tab structure within the web browser's display area. For example, a user can have Firefox browser display with tabs for ESPN, CNN, MSN, and Wall Street Journal web pages. Firefox allows its users to group open these tabs using its group open arrangement method. The user can CTRL-Click the selected hyperlink text and then right-click to open the highlighted document in a new tab under the same browser window. Firefox's print operations, however, still follow the traditional methods discussed previously wherein each page to be printed must be individually viewed and explicitly printed by the user. Firefox does not consolidate multiple printed document into one print job requests, either.

Therefore, there exists a need in the art for a system and method which allows a user to perform a multi-select operation on hyperlinked items in a web page, and to instantiate a print operation which will retrieve the linked documents and pages, search for a printer-friendly version of each document, and consolidate the multiple prints into a single print job.

### BRIEF DESCRIPTION OF THE DRAWINGS

The following detailed description when taken in conjunction with the figures presented herein present a complete description of the present invention.

FIG. 1 shows a portion of a web browser window that can be viewed by a user on a device such as a computer monitor, TV, or personal digital assistant (“PDA”).

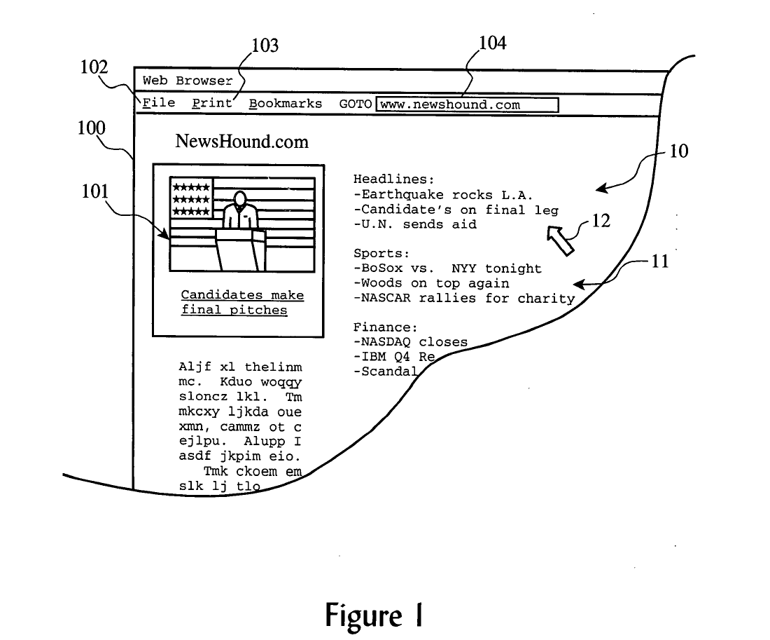

FIG. 2 illustrates the hyperlink text highlighting process.

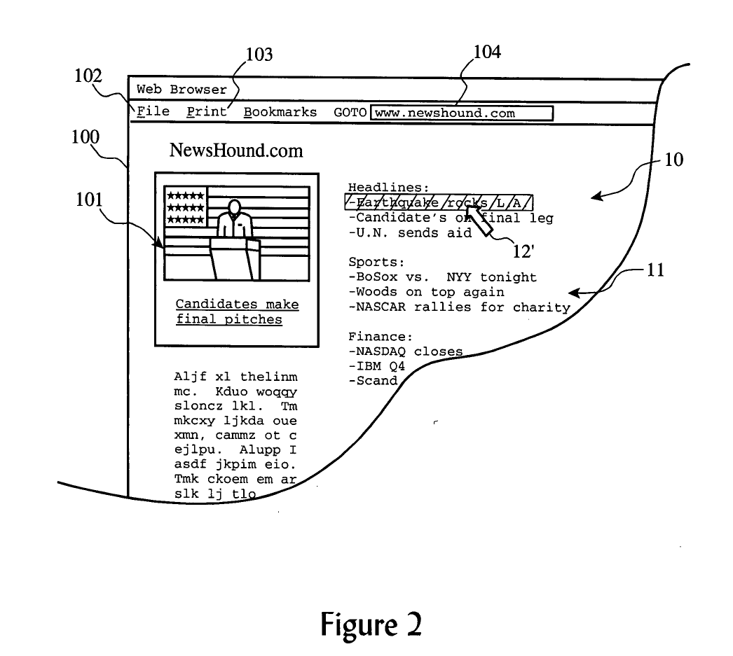

FIG. 3 provides an example of a web page printing process.

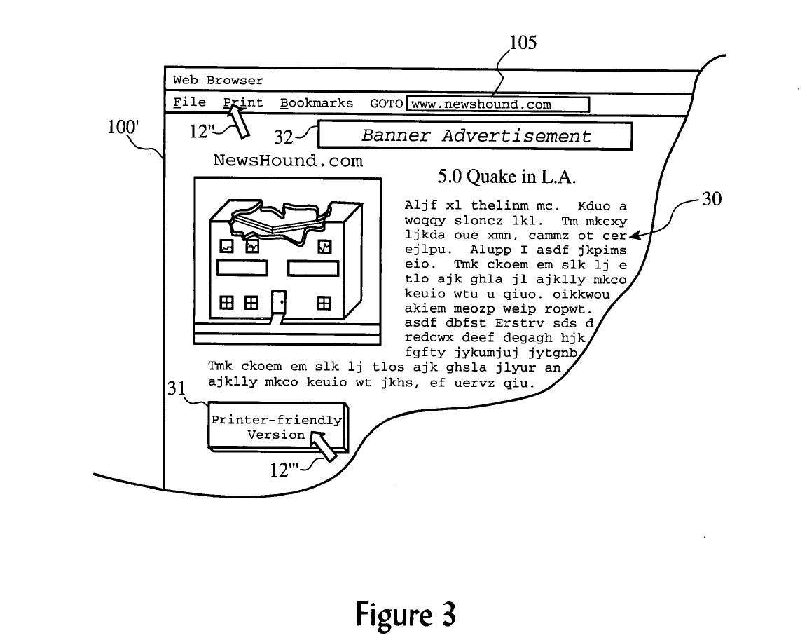

FIG. 4 shows the known manual process to initiate a plurality of individual print jobs for a plurality of web pages and documents.

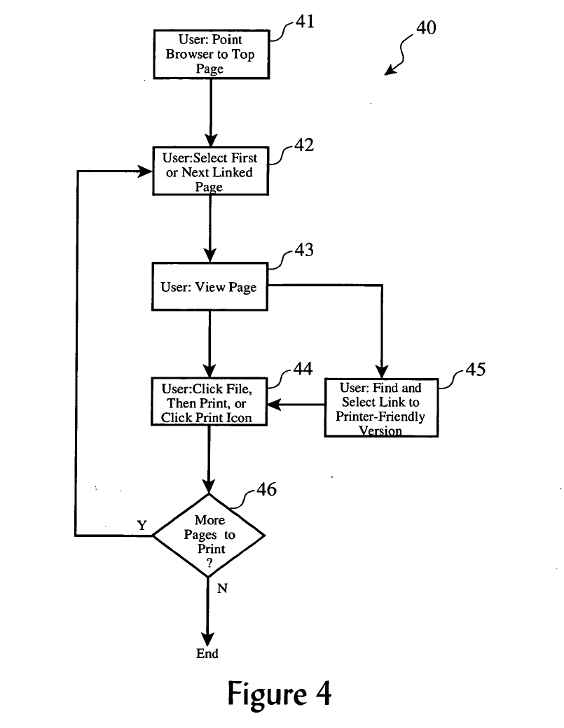

FIG. 5 sets forth the logical process and method of use of the present invention to indicate a number of links to documents to be printed.

FIG. 6 set forth the remainder of the logical process of the invention to process the selected links, linked documents, and print buffer data.

FIG. 7 illustrates page coding options according to the present invention for denoting and finding printer-friendly versions of documents.

FIG. 8 depicts a generalized computing platform architecture, such as a personal computer, server computer, personal digital assistant, web-enabled wireless telephone, or other processor-based device.

FIG. 9 shows a generalized organization of software and firmware associated with the generalized architecture of FIG. 8.

### SUMMARY OF THE INVENTION

The invention provides a mechanism which allows Internet users to efficiently and quickly select multiple links to documents or files within a web page or set of web pages to print, without having to navigate to and review the documents themselves, and without having to manually search for a printable or printer-friendly version of the document. The invention automatically selects the best available document for printing purposes, and consolidates multiple pages or documents into a single print job.

### DETAILED DESCRIPTION OF THE INVENTION

The present invention can be realized as a combination of new functions to a web browser system or product, either through addition of functionality to an existing web browser by such means as a plug-in or Dynamically Linked Library (“DLL”), or through modification of software or circuitry of a web browser. For the purposes of this disclosure, the invention will be referred to as the “Group Print Assistant”, which can be either software coupled with a computing platform, circuitry, or a combination of both.

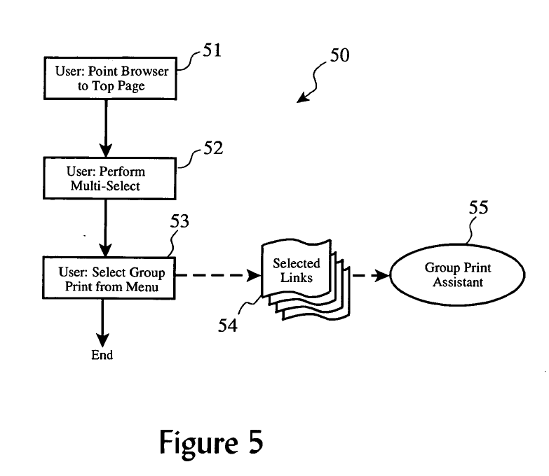

Turning to FIG. 5, a new and more efficient printing process (50) is shown which employs the invention. First, the user can type the URL, address, jump word, keyword, or otherwise “point” his or her web browser to a top page (51), wherein the user finds multiple links to documents which the user wishes to print.

However, rather than navigate to each document, review it, find a printer-friendly version, and execute a print command for each linked document, the user performs a multi-item selection (52) from the top page for each of the linked items which he or she wishes to print. Any of a number of multi-item selection processes may be employed as previously described.

Next, the user then selects and invokes a “Group Print” command, such as selecting an option from a drop-down Print menu, or right-clicking one of the selected items and selecting a “Group Print” command from a pop-up menu. This invokes the invention (55), which receives a set of hyperlinks (54) from the web browser, as indicated in the multi-item selection step previously performed.

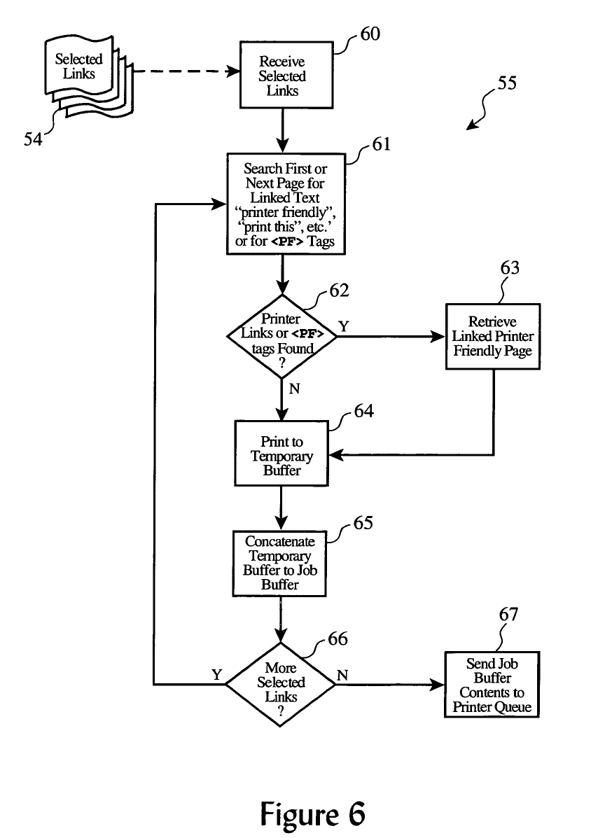

Turning to FIG. 6, a logical process as performed by the Group Print Assistant (55) is shown, which may be performed in part or whole by software, circuitry, or a combination of both. The set of selected hyperlinks (54) which were selected by the user from a top page, and which point to the documents or pages which the user wishes to be printed, are received from the web browser program or system (60).

The invention then searches the first document or web page associated with the first hyperlink in the selected links (54), and looks for an indicator of a printer-friendly version, such as hyperlinked text in the document or page “Print This”, “Printer-Friendly”, etc. A considerable list of variations of this indication text can be quickly searched as it is simple text searching which is very efficiently performed by modern computers.

However, according to one optional aspect of the present invention, special printer-friendly markup tags may also be found so as to allow for the use of non-text web objects to indicate to the user and to the invention the existence of a printer-friendly version, such as a graphic image button or picture (e.g. a GIF or JPG image).

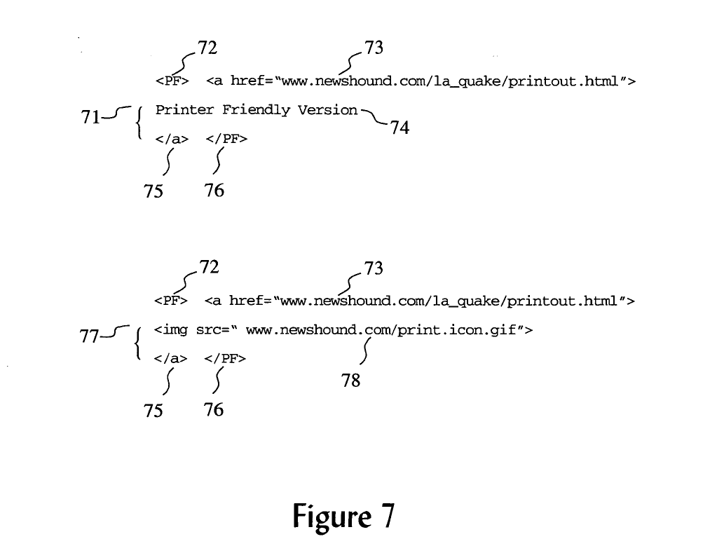

Turning temporarily to FIG. 7, two examples (71, 77) are provided for Hyper Text Markup Language (“HTML”) coding for these search targets are shown. In the first example (71), the display text “Printer Friendly Version” is marked by HTML tags with a hyperlink (73, 75), as well as a new tag which is defined by the present invention which is a “Printer Friendly” tag (72, 76). The “<PF>” value of this tag, and its accompanying closing tag “</PF>” are provided as illustrative examples, but any unique set of tags can be employed for this printer-friendly marking, just as long as the values are not aliases or duplicates with other tags which are used for other purposes.

So, in this first coding example (71), if a document to which a hyperlink points which was selected (54) by the user contains this additional HTML code (71), the invention automatically finds this code and retrieves the printer-friendly version at the provided hyperlink (73) without the need for the user to manually search for and select the embedded hyperlink.

In the second example (77), a graphic image “print_icon” (a GIF image) is surrounded by hyperlink tags (73, 75) and our new printer-friendly tags (72, 76). As with the first example, the printer-friendly tags (72, 76) help the invention find a graphic image such as a button icon which otherwise would visually indicate to the user the availability of a printer-friendly version of the web page or document. The invention retrieves this version, if available, automatically for printing.

Returning to FIG. 6, the Group Print Assistant (55) searches (61) the first document for a link to a printer-friendly version of the document, and if found (62), optionally retrieves (63) that version, and prints (64) the document to a temporary buffer. If no printer-friendly version is found, then the web browser's native page printing function is invoked to print the current page or document to a temporary buffer.

The temporary buffer is then appended (65) to the print job buffer, which is currently empty because this is the first document being processed on the list of selected links (54). In some operating systems, a print job can be built directly in the print buffer, and in other operating systems a print job must be created separately and then sent to the print queue. The invention may be realized in any manner necessary to be compatible with a specific operating system's or computing system's printing scheme.

The document or web page to which the next selected link (54) points is then retrieved and searched (61) for printer-friendly versions, including optionally searching for our special printer-friendly tags (61, 62), printing the web page or document to a temporary buffer (63, 64), and appending the printed document or page to the job buffer (65).

This process is repeated automatically for each document to which a selected link (54) points until all selected links (66) have been handled. As print information is concatenated in the print buffer, a single print job is built prior to sending the job to the print queue. Finally, one print job is sent (67) to the printer queue for printing, which effectively causes the multiple printed documents to be printed as just one print job by the printer, thereby saving paper (e.g. only one separation page) and time (e.g. no waiting by the user for intervening jobs to complete so that all of his or her individual jobs complete).

It should be noted that the example HTML code provided in the foregoing paragraphs is for illustrative purposes only, and the invention may be realized in alternate forms to process other web page and document encoding languages, including but not limited to eXtensible Markup Language (“XML”), Wireless Markup Language (“WML”), Hewlett-Packard Graphics Language (“HPGL”), and Printer Control Language (“PCL”).

According to an enhanced embodiment of the present invention, the user may perform multiple item selection not only within a single web page or single web document, but may also perform selections of multiple items across different “tabs” within a web browser instance, or multiple items across multiple instances of web browsers or other application programs. In the case of the latter operation, the list of selected links would be prepared in part or whole by the operating system or file navigation system, using code modifications or additions according to the present invention.

The present invention may be realized for use in a Microsoft Windows operating system environment, as illustrated in the foregoing paragraphs, but may alternately be realized in other computing environments, including but not limited to Palm Computing's PalmOS™, IBM's AIX™, Unix, Linux, Sun Microsystem's Solaris, Novell's Netware, etc. Further, the present invention can equally well cooperate with, reside in, or form an extension to any suitable web browser system or program, including but not limited to Netscape's Navigator™, Microsoft's Internet Explorer™, and Mozilla's FireFox™.

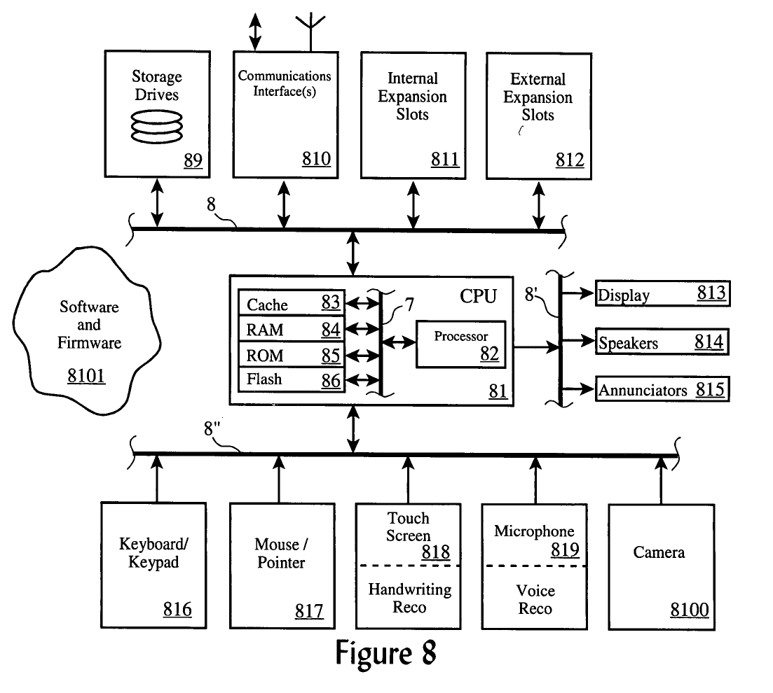

As the present invention is preferably realized in part or whole as a software product executed by a suitable computer, we now turn to FIG. 8, which shows a generalized architecture of a suitable computing platform, including optional and optimal components. Such a computing platform may span the range of implementation, from a high-end web or enterprise server platform, to a personal computer, to a portable PDA or web-enabled wireless phone.

As shown in FIG. 8, a generalized architecture of a computing platform includes a central processing unit (81) (“CPU”), which is typically comprised of a microprocessor (82) associated with random access memory (“RAM”) (84) and read-only memory (“ROM”) (85). Often, the CPU (81) is also provided with cache memory (83) and programmable FlashROM (86). The interface (87) between the microprocessor (82) and the various types of CPU memory is often referred to as a “local bus”, but also may be a more generic or industry standard bus.

Many computing platforms are also provided with one or more storage drives (89), such as hard-disk drives (“HDD”), floppy disk drives, compact disc drives (CD, CD-R, CD-RW, DVD, DVD-R, etc.), and proprietary disk and tape drives (e.g., lomega Zip™ and Jaz™, Addonics SuperDisk™, etc.). Additionally, some storage drives may be accessible over a computer network.

Many computing platforms are provided with one or more communication interfaces (810), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (811), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (812) allowing the user the ability to easily install and remove hardware expansion devices, such as PCMCIA cards, SmartMedia cards, and various proprietary modules such as removable hard drives, CD drives, and floppy drives.

Often, the storage drives (89), communication interfaces (810), internal expansion slots (811) and external expansion slots (812) are interconnected with the CPU (81) via a standard or industry open bus architecture (88), such as ISA, EISA, or PCI. In many cases, the bus (88) may be of a proprietary design.

A computing platform is usually provided with one or more user input devices, such as a keyboard or a keypad (816), and mouse or pointer device (817), and/or a touch-screen display (818). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (818) is usually provided, often with handwriting recognition capabilities.

Additionally, a microphone (819), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (8100), such as a still digital camera or full motion video digital camera.

One or more user output devices, such as a display (813), are also provided with most computing platforms. The display (813) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (814) and/or annunciators (815) are often associated with computing platforms, too. The speakers (814) may be used to reproduce audio and music, such as the speaker of a wireless telephone or the speakers of a personal computer. Annunciators (815) may take the form of simple beep emitters or buzzers, commonly found on certain devices such as PDAs and PIMs.

These user input and output devices may be directly interconnected (8′, 8″) to the CPU (81) via a proprietary bus structure and/or interfaces, or they may be interconnected through one or more industry-standard open buses such as ISA, EISA, PCI, etc. The computing platform is also provided with one or more software and firmware (8101) programs to implement the desired functionality of the computing platforms.

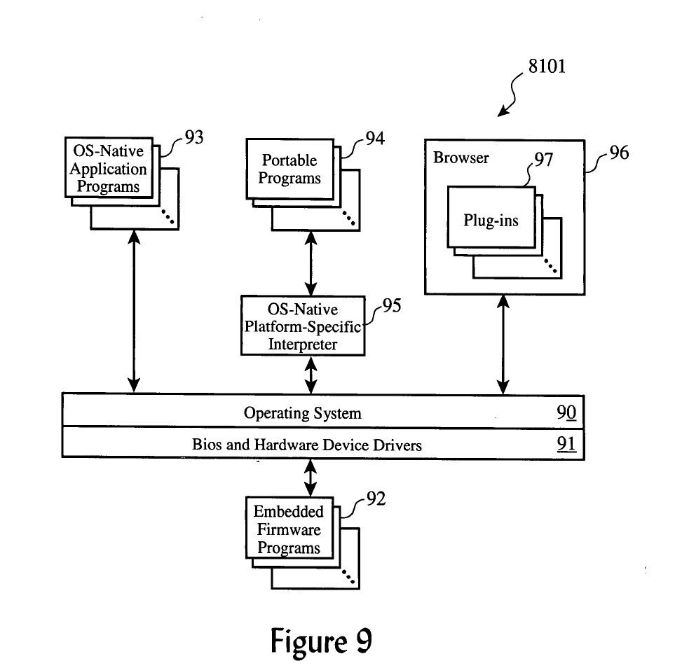

Turning to now FIG. 9, more detail is given of a generalized organization of software and firmware (8101) on this range of computing platforms. One or more operating system (“OS”) native application programs (93) may be provided on the computing platform, such as word processors, spreadsheets, contact management utilities, address book, calendar, email client, presentation, financial and bookkeeping programs.

Additionally, one or more “portable” or device-independent programs (94) may be provided, which must be interpreted by an OS-native platform-specific interpreter (95), such as Java™ scripts and programs.

Often, computing platforms are also provided with a form of web browser or micro-browser (96), which may also include one or more extensions to the browser such as browser plug-ins (97).

The computing device is often provided with an operating system (90), such as Microsoft Windows™, UNIX, IBM OS/2™, LINUX, MAC OS™ or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (91) are often provided to allow the operating system (90) and programs to interface to and control the specific hardware functions provided with the computing platform.

Additionally, one or more embedded firmware programs (92) are commonly provided with many computing platforms, which are executed by onboard or “embedded” microprocessors as part of the peripheral device, such as a micro controller or a hard drive, a communication processor, network interface card, or sound or graphics card.

As the foregoing paragraphs have described in detail and with examples certain embodiment options, aspects and features of the present invention, it will be readily recognized by those skilled in the art that these illustrative embodiments do not define the extent of the present invention as many other embodiment alternatives may be made within the skill of the art according to the present disclosure. Therefore, the scope of the present invention should be determined by the following claims.

What is claimed is:

1. A system for preparing and printing a plurality of documents under user command via a web browser interface, said system comprising:
a multiple-link selection user interface tool configured to allow a user to select a plurality of links to web pages and documents;
a selected links list receiver configured to receive a list containing a plurality of links selected using said multiple-link selection tool;
a document retriever configured to retrieve each document or web page corresponding to each link in said list; and
a print job concatenater adapted to print each of said retrieved documents into a preparation buffer, each of said printed documents being appended to the totality of said buffer, and configured to transfer the contents of said buffer to a printer for printing.

2. The system as set forth in claim 1 wherein said list receiver is configured to receive a list of links from a web browser program.

3. The system as set forth in claim 1 wherein said list receiver is configured to receive a list of links from an operating system.

4. The system as set forth in claim 1 wherein said multiple-link selection user interface tool is adapted to select links across multiple views within a web browser.

5. The system as set forth in claim 1 wherein said multiple-link selection user interface tool is adapted to select links across multiple application programs.

6. The system as set forth in claim 1 wherein said document retriever comprises a printer-friendly searcher adapted to search for a link to a printer-friendly version of each retrieved document, and if found, to retrieve and print said printer-friendly version of each document into said preparation buffer in place of said retrieved document.

7. The system as set forth in claim 6 wherein said searcher is adapted to search for a printer-friendly markup tag.

8. The system as set forth in claim 6 wherein said searcher is adapted to search for a hyperlinked string of text indicating the availability of a printer-friendly version of a document.

9. A method for preparing and printing a plurality of documents under user command via a web browser interface, said method comprising the steps of:
receiving a list containing a plurality of links to web pages or documents, said plurality of links having been selected by a user from one or more web pages or documents using a multiple-link selection tool;
retrieving each document or web page corresponding to each link in said received list;
concatenating a print of each of said retrieved documents into a preparation buffer, each of said printed documents being appended to the totality of said buffer; and
transferring the contents of said preparation buffer to a printer for printing.

10. The method as set forth in claim 9 wherein said step of receiving a list of links comprises receiving a list of links from a web browser program.

11. The method as set forth in claim 9 wherein said step of receiving a list of links comprises receiving a list of links from an operating system.

12. The method as set forth in claim 9 wherein said received list comprises links selected across multiple views within a web browser.

13. The method as set forth in claim 9 said received list comprises links selected across multiple application programs.

14. The method as set forth in claim 9 further comprising searching for a link to a printer-friendly version within each retrieved document and web page, and if found, retrieving and printing said printer-friendly version of each document into said preparation buffer in place of said retrieved document.

15. The method as set forth in claim 14 wherein said step of searching comprises searching for a printer-friendly markup tag.

16. The method as set forth in claim 14 wherein said step of searching comprises searching for a hyperlinked string of text indicating the availability of a printer-friendly version of a document.

17. A computer-readable medium encoded with software for preparing and printing a plurality of documents under user command via a web browser interface, said software performing the steps of:
receiving a list containing a plurality of links to web pages or documents, said plurality of links having been selected by a user from one or more web pages or documents using a multiple-link selection tool;
retrieving each document or web page corresponding to each link in said received list;
concatenating a print of each of said retrieved documents into a preparation buffer, each of said printed documents being appended to the totality of said buffer; and
transferring the contents of said preparation buffer to a printer for printing.

18. The medium as set forth in claim 17 wherein said software for receiving a list of links comprises software for receiving a list of links from a web browser program.

19. The medium as set forth in claim 17 wherein said software for receiving a list of links comprises software for receiving a list of links from an operating system.

20. The medium as set forth in claim 17 wherein said received list comprises links selected across multiple views within a web browser.

21. The medium as set forth in claim 17 wherein said received list comprises links selected across multiple application programs.

22. The medium as set forth in claim 17 further comprising software for searching for a link to a printer-friendly version within each retrieved document and web page, and if found, retrieving and printing said printer-friendly version of each document into said preparation buffer in place of said retrieved document.

23. The medium as set forth in claim 22 wherein software for searching comprises software for searching for a printer-friendly markup tag.

24. The medium as set forth in claim 22 wherein said software for searching comprises software for searching for a hyperlinked string of text indicating the availability of a printer-friendly version of a document.
